(19) United States
(12) Patent Application Publication
(10) Pub. No.: US 2011/0010212 A1
(43) Pub. Date: Jan. 13, 2011

(54) Trainee Incentive and Reward Method

(76) Inventor: William J. Sims, Chapin, SC (US)

Correspondence Address: CALHOUN "REB" THOMAS, III, 1201 MAIN STREET, SUITE 1750, COLUMBIA, SC, 29201, US

(21) Appl. No.: 12/667,165

(22) PCT Filed: Jul. 1, 2008
(86) PCT No.: PCT/US2008/068912

§ 371 Date: Dec. 29, 2009

Related U.S. Application Data
(60) Provisional application No. 60/947,499, filed on Jul. 2, 2007.

(51) Int. Cl. G06Q 30/00; G06Q 90/00; G06Q 10/00

(52) U.S. Cl. 705/7; 705/500; 705/14.1

(57) ABSTRACT

The invention is a method and system that provides for efficiently incentivising and rewarding employees for their successful use of the training system or other employer metrics by utilizing rewards such gift cards or discount coupons redeemable for goods and/or services at retail/service centers.

### RELATED APPLICATIONS

This application claims the benefit of U.S. application Ser. No. 60/947,499.

### FIELD OF THE INVENTION

The present invention relates to the field of employee incentives and in particular to a method of incentivising and rewarding employees whereby incentive coupons are presented to employees after they satisfactorily complete a training module, meet health/fitness goals, or otherwise satisfactorily perform actions that the employer wants to incentivise.

### SUMMARY OF THE INVENTION

It is an object of the present invention to provide a novel method for efficiently incentivising and rewarding employees for their successful use of the training system, health regime, or other employer defined performance metrics by utilizing rewards in the form of gifts or discount coupons redeemable for goods and/or services at retail/service centers. In alternate embodiments, these discount coupons are only redeemed when further combined with employees' own money. This system provides employers with a way of infusing incentive and training goals into an employment setting with a balanced cost. The boundaries of the present invention are not limited by the brick and mortar, pen and paper world as the invention may be utilized via the internet or other virtual settings.

In this novel way, the present invention includes discrete steps applied to train or otherwise measure progress of employees, reward employees, and capture the essence of the applied reward as it relates to the completed training module or satisfied performance metric. Thus, the system is designed to concentrate the reward so as to parallel the benefit gained by the employer via the training or performance metric.

### BRIEF DESCRIPTION OF THE SEVERAL VIEWS OF THE DRAWINGS

FIG. 1 is a flow diagram showing the basic method without a 3^{rd} party card provider.

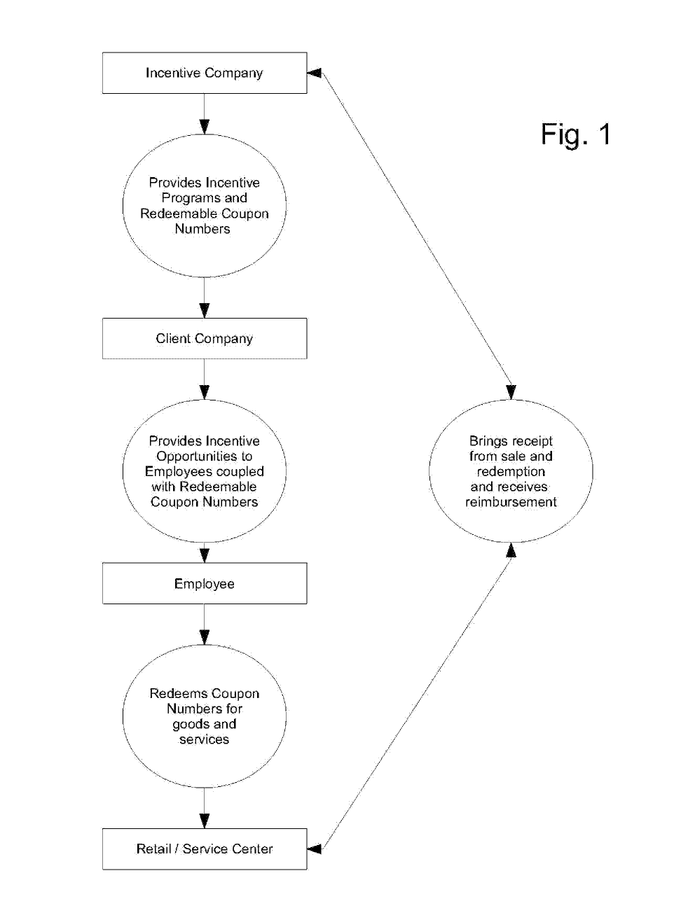

FIG. 2 is a flow diagram showing the basic method utilizing a 3^{rd} party card provider.

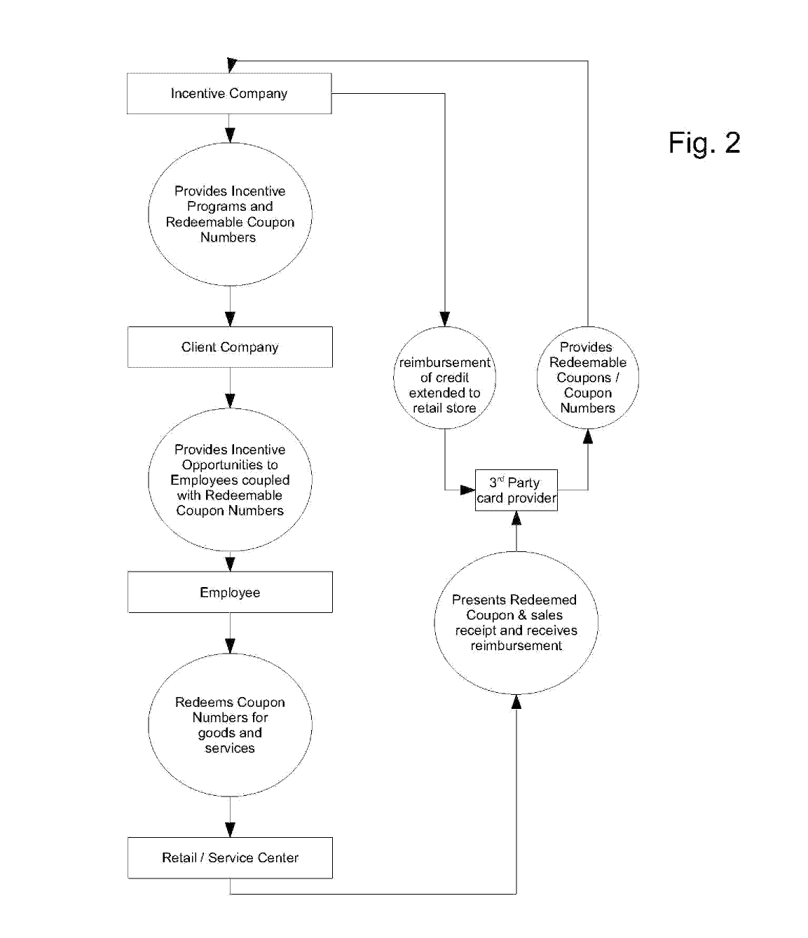

FIG. 3 is a flow diagram showing the utilization of a you-did-it-right card as part of the method.

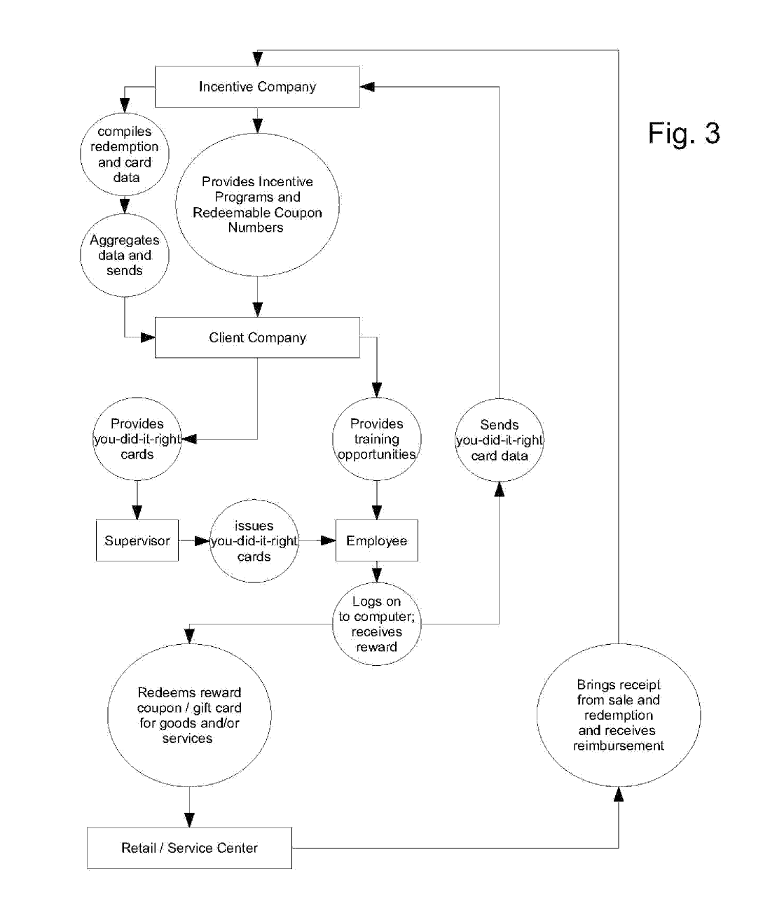

FIG. 4 is a flow diagram showing the utilization of a smartcard as part of the method.

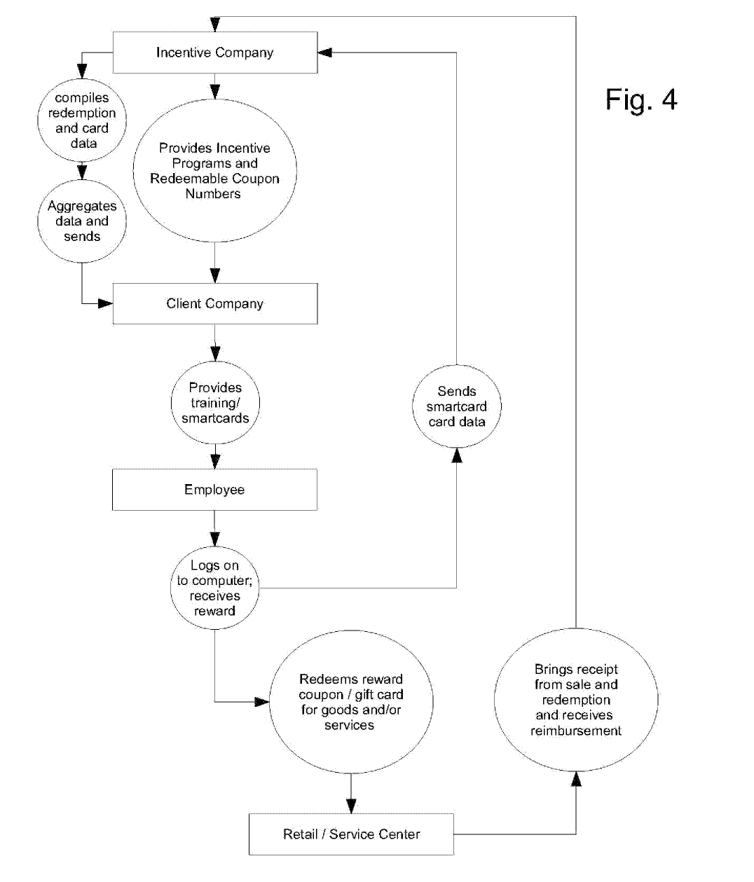

FIG. 5 is a flow diagram showing the health screening embodiment of the method.

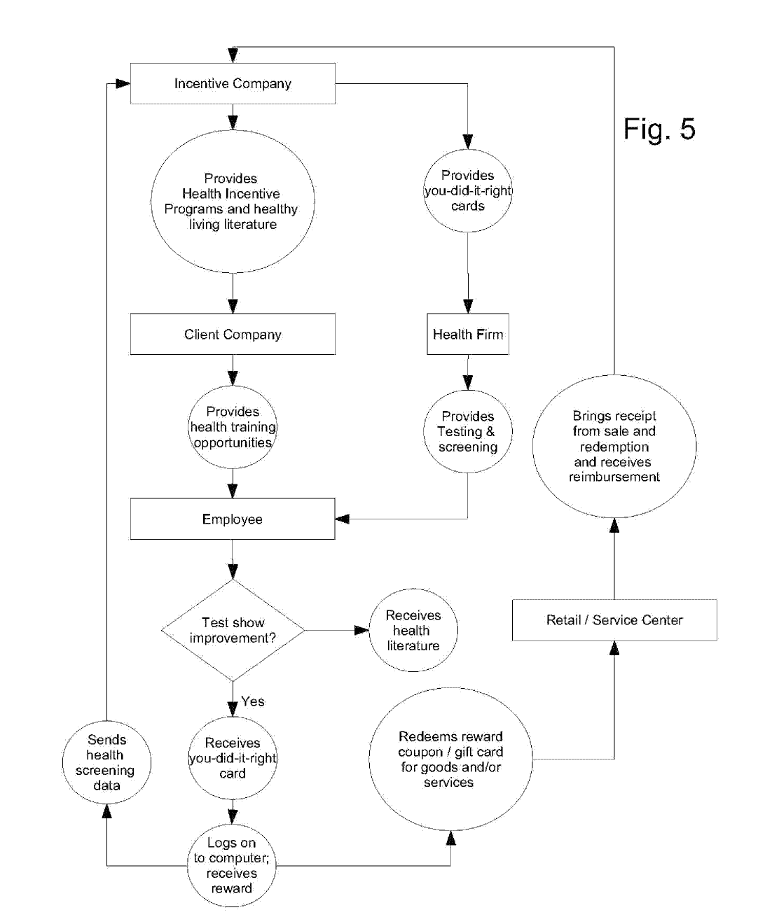

### DETAILED DESCRIPTION

It is to be understood by a person having ordinary skill in the art that the present discussion is a description of exemplary embodiments only, and is not intended as limiting the broader aspects of the present invention. The following examples are provided to further illustrate the invention and are not to be construed to unduly limit the scope of the invention.

The present invention is defined by a number of steps with different actors or entities carrying out those steps. Typically, there are 4 or 5 principal actors. Depending on the particular embodiment, these actors can be identified by a number of different labels some of which will be explained herein.

The first actor is the client company. The client company is any organization that has a need to train or otherwise monitor and improve the performance of its individual constituents. Typically, this is a company that needs to train or monitor its employees. For instance, the company might wish to train employees about a new procedure, or monitor efficient use of a machine, or even monitor and train regarding safety and personal health procedures. However, the client company could also be a school, a sports team, a government agency, or other such organizations. A school might wish to monitor teachers or educate students. The sports team might need to teach a technique or monitor personal health practices. Likewise, a government agency might need to train its employees.

A second actor is the individual employee. The employee is any human constituent of an organization that needs to be trained, incentivized, or otherwise monitored. Typically the employee works for a company but the employee could be a student, team member, or even an independent contractor performing work for the client company.

A third actor is the retail store or other entity that accepts reward cards and coupons from the employee and grants discounts on purchases of goods or services. This retail store offers goods or services to the employee. It can operate from brick and mortar store fronts or it can be virtual in nature operating via the Internet. In the preferred embodiment, the retail store or service center's trade name will appear on the face of the coupon. In one embodiment, several different retail stores may have their trademarks appear in connection with a single reward and coupon such that a single coupon may be redeemable at one of multiple retail stores.

A fourth actor is the incentive company. This entity provides training modules, health assessments, or performance metrics to the client company along with correlated rewards and coupons. In alternate embodiments, the incentive company either produces the rewards and coupons itself, receives the rewards and coupons from the retail store, or receives the rewards and coupons from a third party card provider.

A fifth actor is a third party card provider. The third party card provider exists in alternate embodiments in order to facilitate the reward and coupon transfers between the retail establishments and the incentive company. As such, the third party card provider issues gift card rewards and/or the coupon rewards. This company can also extend credit to the incentive company to cover the potential for coupon redemption.

In addition to the principal actors, there are important concepts to define with respect to the present invention. First, there is the training module. The training module is a training process designed by the incentive company to meet the training needs of the client company. This module includes many different approaches to train the employees. Typically the training module will include an instruction step and a testing step.

The instruction step is used to convey individual nuggets of information to the employee. This instruction step could include seminars, lectures, demonstrations, or wall posters among many others. The instruction step subject matter can vary greatly. It might involve instructions on proper use of a piece of machinery or it might involve work place etiquette. Further, the instruction step subject might extend to personal health and fitness or problem solving skills.

One embodiment of the instruction step utilizes a concept called “smart cards.” In this embodiment, the important nuggets of information are displayed in the facility on a poster for the employees to observe on a daily basis. In the preferred embodiment, these same nuggets are reproduced in miniature form on a small card, called a smart card, that the employee can carry around for reference and review. This smart card could be a physical card made of paper or other three dimensional material or it could be an email or other electronic form. In any event, the smart card will have a series of desired learning points displayed thereon that the employee is advised to study.

Likewise, the testing step can take many forms. In the preferred embodiment, the employee is tested on the information contained on the smart card or other embodiments of the instruction step via a computer terminal. This terminal could be located in a kiosk in the facility or it could be a personal or office computer. A computer program running on the terminal would present a series of questions to the employee related to the nuggets on the smart card. The employee would input answers via the computer to satisfy the testing step. In alternate embodiments, in place of a computer terminal, the testing step could utilize a telephone or other means such as paper mail forms.

In the case of the smart card embodiment, the smart card itself would also include an alpha-numeric identifier that is entered by the employee into the computer terminal so that the terminal knows which questions apply to the data contained on the smart card. Likewise, the alpha-numeric identifier could be entered via telephone or via other means such as paper mail forms

The training module may also be a set of performance metrics used to monitor and judge the performance of employees for particular tasks and job requirements. For instance, employers would monitor employees to see if they are performing satisfactorily in compliance with these metrics. Observation of compliance with these metrics would parallel successful testing in the testing sub-step. Employees would, thus, be expected to demonstrate information gleaned in the instruction step by integrating that information into their job performance. When the supervisors notice the advancement based on the nuggets, the employee would satisfy the testing step requirements. In one embodiment of this form of the training and testing module, the supervisor would be given a number of “you-did-it-right” cards, and, upon observing compliance with the performance metrics, would be entitled to distribute the you-did-it-right cards to the respective employees. The you-did-it-right card would have an alpha-numeric identifier and also have fields for the supervisor to fill in such information as the ID number of the employee observed, the ID number of the supervisor who observed the employee, the date observed, and check boxes for the behaviors observed in compliance with the training step. To complete the testing step, the employee would enter this information from the you-did-it-right card along with the alpha-numeric number into the computer terminal or other means such as a telephone.

Another concept that needs to be defined is the critical rewards concept. The reward is a valuable offering provided upon the satisfactory completion of the testing step of a training module. Typically the client company is seen as conferring the reward on the employee. The reward, however, may originate from a variety of sources, including the incentive company as in the preferred embodiment. The reward may be a physical good and it may also be a gift card that can be redeemed. In one embodiment of the present invention, the reward is a discount coupon that can be redeemed at the retail store. This coupon can take on a variety of forms. It could literally be a piece of paper indicating a discount on a particular brand item, on a particular class of goods, from a particular store, or from a particular group of stores. For example the coupon might apply to Nike® shoes from any store, or to any footwear from any store, or to any goods from a Foot Locker® store, or to any goods from a Foot Locker® or a Wal-Mart® store, or to an Olive Garden Italian Restaurant® eating establishment or to any combination thereof.

Importantly, the coupon is not limited to the brick and mortar world, that is, it can be used in the virtual world of the Internet. Each coupon will have a unique identification number associated with it as well as other information about the value of the reward, the redemption locations to which it is tied, and any other applicable conditions. The identification number can be entered in the appropriate manner on a website of a retail store that honors the coupon. In this way, the holder of the coupon would be able to use the identification number to redeem the reward over the Internet. Additionally, this identification number may be displayed literally using Arabic numerals but it could be represented via scanner/computer readable bar code or otherwise with imbedded binary numbers readable by a computer.

As for the value of the reward, the amount could vary considerably. In the coupon embodiment however, the basic concept is that the employee would be offered a discount. In many cases the employee would still required to convey some of his or her own money in order to complete the transaction. The coupon could, thus, be $5.00 off of a purchase of $10.00 or $50.00 off of a purchase of $100.00. Just the same, the coupon could be $25% off total purchase or 50% off of a single item purchase. Moreover, the coupon could also be for $20.00 off of a purchase of $20.00 or more in which case the employee would not have to use any of his or her own money if the purchase amounted to exactly $20.00.

Utilizing these entities and concepts, the present invention contemplates a system whereby incentive companies contract either directly with retail stores or through third party card providers to obtain redeemable coupons. The incentive companies also contract with client companies to provide training modules and reward packages integrating the redeemable coupons. When the training modules are satisfactorily completed by the trainees or employees, reward coupons are distributed to the employees. The employees then take the coupons to the relevant retail store front, either the physical store or the online store, where the employees make purchases using their own money in combination with the discount coupon. The retailer (or service provider) then, having extended provisional credit to the coupon generator, applies to the respective coupon generator, that is either to the third party card provider or directly to the incentive company. In the case of the third party card provider, that entity will then, in turn, apply the redeemed coupon to the incentive company for reimbursement.

A final step in alternate embodiments occurs after the primary cycle has been completed, that is, after the instruction, the testing, the rewarding, the redemption, the re-imbursement, etc. . . . . This final step is the reporting step and involves the aggregation of data by the incentive company and then the reporting back to the client company this data. For instance, in a hypothetical manufacturing setting, the incentive company would provide the client company with smart cards and associated potential rewards to teach ergonomic methods for lifting a box. The client company would offer instruction to the employees and distribute the smart cards to the employees. The employees would then access a computer terminal, enter the smart card alpha numeric number, take a test, receive a reward for passing the test, and redeem the reward at a retail location. The retail center then seeks reimbursement (as necessary such as for the coupon embodiment) from either the third party card provider or the incentive company as necessitated by the particular embodiment. The incentive company receives information on test passage rates regarding the various employees via the computer terminal and data regarding their respective redemptions of rewards via retail centers and/or the third party card providers. The incentive company then aggregates, analyzes, and reports the data to the client company.

Likewise, in a hypothetical manufacturing setting where you-did-it-right cards are utilized, the incentive company would provide the client company with the you-did-it-right cards and associated potential rewards to reward successful utilization of ergonomic methods for lifting a box. The client company distributes the you-did-it-right cards to supervisors to use to reward employees. The employees, having received a you-did-it-right card would then access a computer terminal, enter the you-did-it-right card data, receive a reward, and redeem the reward at a retail location. The retail center then seeks reimbursement (as necessary such as for the coupon embodiment) from either the third party card provider or the incentive company as necessitated by the particular embodiment. The incentive company receives information entered into the terminal by the employee from the card regarding the success of the employee as well as the supervisor who observed the success. Communicating with the retail center or the third party card provider, the incentive company also receives data regarding the respective redemptions of rewards. The incentive company then aggregates, analyzes, and reports the data to the client company.

Another way the you-did-it-right card concept may be used is in a peer review situation where peer employees (instead of supervisors) review positive or negatives implementations of the instruction step. Here, the incentive company would provide the client company with the you-did-it-right cards and associated potential rewards to reward to incentivise successful identification of successes and/or failures to following the training step. The client company distributes the you-did-it-right cards to employees, the employees observe their peers, and describe safety hazards and mistakes and/or successes of other employees. The employees, having filled out their you-did-it-right card would then access a computer terminal, enter the you-did-it-right card data identifying the safety hazards created by others or the successes of others, enter the alpha-numeric identifier, receive a reward, and redeem the reward at a retail location. The retail center then seeks reimbursement (as necessary such as for the coupon embodiment) from either the third party card provider or the incentive company as necessitated by the particular embodiment. The incentive company then receives information entered into the terminal by the employee from the card regarding the peer and workplace review by the employee of the other employees. Communicating with the retail center or the third party card provider, the incentive company also receives data regarding the respective redemptions of rewards. The incentive company then aggregates, analyzes, and reports the data to the client company, thereby allowing the company to have a record of success and failures while allowing whistle blowers the benefit of anonymity.

Likewise, in a hypothetical business or manufacturing setting where aggregate employees' health is being promoted, monitored and rewarded, the incentive company would provide the client company with literature regarding healthy living. The incentive company or a medical firm would schedule health screenings whereby employees are examined. When employees receive positive check ups or otherwise show improvement in health, such as an improved cholesterol score, the employees are given you-did-it right cards. The employees, having received a you-did-it-right card would then access a computer terminal, enter the you-did-it-right card data, receive a reward, and redeem the reward at a retail location. The retail center then seeks reimbursement (as necessary such as for the coupon embodiment) from either the third party card provider or the incentive company as necessitated by the particular embodiment. The incentive company then receives information entered into the terminal by the employee from the you-did-it-right card regarding the health status of the employee. Communicating with the retail center or the third party card provider, the incentive company also receives data regarding the respective redemptions of rewards. The incentive company then aggregates, analyzes, and reports the data to the client company. As such, without disclosing private health data of individual employees, the incentive company is able to report on the aggregate health of the client company's work force as well as any improvements. Further, the incentive company will be able to tailor health incentive programs for higher risk employees without penetrating the employee/employer privacy wall.

What is claimed is:

1. A method of training and rewarding a trainee comprising the steps of:
Step 1) providing an incentive company, a client company, a plurality of employees of said client company, and a retail center;
Step 2) said incentive company providing a training module and a rewards package to said client company;
Step 3) said client company providing instruction opportunities to said employees;
Step 4) said client company providing testing opportunities to said employees wherein the information contained in said instruction opportunities provided in step 3 is tested;
Step 5) said client company providing a reward to said employees for satisfactory completion of the testing in step 4, said client company having been provided with said rewards as part of said rewards package provided in step 2;
Step 6) said employee redeeming the reward from said retail center; and
Step 7) said retail center receiving reimbursement from said incentive company.

2. The method of training and rewarding a trainee of claim 1 wherein the instruction opportunities provided in step 3 comprises large training posters and smart cards wherein said smart cards have disposed thereon important nuggets of information and are coded with an alpha-numeric identifier.

3. The method of training and rewarding a trainee of claim 2 wherein the testing opportunities provided in step 4 further comprises the sub-steps of:
Step 4A) providing a computer terminal containing computer code directed to a testing program and linked to said incentive company's network;
Step 4B) said employees entering the alpha-numeric identifiers from said smart cards into said computer terminal;
Step 4C) said computer terminal linking said alpha-numeric identifiers with a set of test questions linked to the information contained on said smart card; and
Step 4D) said employee taking the test via the computer terminal linked and provided in Step 4C.

4. The method of training and rewarding a trainee of claim 3 wherein the reward provided in step 5 is a discount coupon having a unique identification number, information about in which retail centers said discount coupon may be redeemed, and details about the respective amounts of the redemptive value.

5. The method of training and rewarding a trainee of claim 4 further comprising the additional steps of:
Step 8) said incentive company compiling statistics through the aggregation of data on employee test passage rates and coupon redemptions;
Step 9) said incentive company analyzing statistics compiled in step 8; and
Step 10) said incentive company reporting statistics and respective analysis to said client company.

6. The method of training and rewarding a trainee of claim 2 wherein the testing opportunities provided in step 4 further comprises the sub-steps of:
Step 4A) providing supervisors of employees with you-did-it-right cards that comprise an alpha-numeric identifier and spaces for biographic information to be filled in by the supervisor and
Step 4B) observing work habits of employees by supervisors for compliance with the instruction opportunities presented in step 2.

7. The method of training and rewarding a trainee of claim 6 wherein the reward given in step 5 is a you-did-it-right card which was provided to the supervisors in step 4A.

8. The method of training and rewarding a trainee of claim 7 wherein the alpha-numeric number printed on the you-did-it-right card links to a discount coupon having a unique identification number, information about in which retail centers said discount coupon may be redeemed, and details about the respective amounts of the redemptive value.

9. The method of training and rewarding a trainee of claim 8 further comprising the additional steps of:
Step 8) said incentive company compiling statistics through the aggregation of data on supervisor's distribution and employee's reception of you-did-it-right cards and coupon redemptions;
Step 9) said incentive company analyzing statistics compiled in step 8; and
Step 10) said incentive company reporting statistics and respective analysis to said client company.

10. The method of training and rewarding a trainee of claim 3 wherein the reward provided in step 5 is a gift card having a unique identification number, information about in which retail centers said gift card may be spent, and details about the respective amounts of the encoded value.

11. The method of training and rewarding a trainee of claim 10 further comprising the additional steps of:
Step 8) said incentive company compiling statistics through the aggregation of data on employee test passage rates and coupon redemptions;
Step 9) said incentive company analyzing statistics compiled in step 8; and
Step 10) said incentive company reporting statistics and respective analysis to said client company.

12. The method of training and rewarding a trainee of claim 7 wherein the alpha-numeric number printed on the you-did-it-right card links to a gift card having a unique identification number, information about in which retail centers said gift card may be spent, and details about the respective amounts of the encoded value.

13. The method of training and rewarding a trainee of claim 12 further comprising the additional steps of:
Step 8) said incentive company compiling statistics through the aggregation of data on supervisor's distribution and employee's reception of you-did-it-right cards and coupon redemptions;
Step 9) said incentive company analyzing statistics compiled in step 8; and
Step 10) said incentive company reporting statistics and respective analysis to said client company.

14. A method of training and rewarding a trainee comprising the steps of:
Step 1) providing an incentive company, a client company, a plurality of employees of said client company, a third party card provider, and a retail center;
Step 2) said third party card provider providing redeemable rewards cards on credit to said incentive company;
Step 3) said incentive company providing a training module and a rewards package to said client company;
Step 4) said client company providing instruction opportunities to said employees;
Step 5) said client company providing testing opportunities to said employees wherein the information contained in said instruction opportunities provided in step 3 is tested;
Step 6) said client company providing a reward to said employees for satisfactory completion of the testing in step 4, said client company having been provided with said rewards as part of said rewards package provided in step 2;
Step 7) said employee redeeming the reward from said retail center;
Step 8) said retail center presenting redeemed reward card and sales receipt and receiving reimbursement from said third party card provider; and
Step 9) said third party card provider receiving reimbursement from said incentive company for credit extended in step 2.

15. The method of training and rewarding a trainee of claim 14 wherein the instruction opportunities provided in step 4 comprises large training posters and smart cards wherein said smart cards have disposed thereon important nuggets of information and are coded with an alpha-numeric identifier.

16. The method of training and rewarding a trainee of claim 15 wherein the testing opportunities provided in step 5 further comprises the sub-steps of:
Step 5A) providing a computer terminal containing computer code directed to a testing program and linked to said incentive company's network;
Step 5B) said employees entering the alpha-numeric identifiers from said smart cards into said computer terminal;
Step 5C) said computer terminal linking said alpha-numeric identifiers with a set of test questions linked to the information contained on said smart card; and
Step 5D) said employee taking the test via the computer terminal linked and provided in Step 5C.

17. The method of training and rewarding a trainee of claim 16 wherein the reward provided in step 6 is a discount coupon having a unique identification number, information about in which retail centers said discount coupon may be redeemed, and details about the respective amounts of the redemptive value.

18. The method of training and rewarding a trainee of claim 17 further comprising the additional steps of:
Step 10) said incentive company compiling statistics through the aggregation of data on employee test passage rates and coupon redemptions;
Step 11) said incentive company analyzing statistics compiled in step 8; and
Step 12) said incentive company reporting statistics and respective analysis to said client company.

19. The method of training and rewarding a trainee of claim 15 wherein the testing opportunities provided in step 4 further comprises the sub-steps of:
Step 5A) providing supervisors of employees with you-did-it-right cards that comprise an alpha-numeric identifier and spaces for biographic information to be filled in by the supervisor and
Step 5B) observing work habits of employees by supervisors for compliance with the instruction opportunities presented in step 3.

20. The method of training and rewarding a trainee of claim 19 wherein the reward given in step 6 is a you-did-it-right card which was provided to the supervisors in step 5A.

21. The method of training and rewarding a trainee of claim 20 wherein the alpha-numeric number printed on the you-did-it-right card links to a discount coupon having a unique identification number, information about in which retail centers said discount coupon may be redeemed, and details about the respective amounts of the redemptive value.

22. The method of training and rewarding a trainee of claim 21 further comprising the additional steps of:
Step 10) said incentive company compiling statistics through the aggregation of data on supervisor's distribution and employee's reception of you-did-it-right cards and coupon redemptions;
Step 11) said incentive company analyzing statistics compiled in step 10; and
Step 12) said incentive company reporting statistics and respective analysis to said client company.

23. A method of training and rewarding a trainee comprising the steps of:
Step 1) providing an incentive company, a client company, a plurality of employees of said client company, a medical firm, and a retail center;
Step 2) said incentive company providing a health fitness training module to said client company;
Step 3) said client company providing health fitness instruction opportunities to said employees;
Step 4) said medical firm conducting medical examinations and health screenings of employees;
Step 5) said medical firm providing results of the examinations and screenings provided in step 4 to said incentive company;
Step 6) said incentive company providing rewards to said employees for positive results and health improvements;
Step 7) said employee redeeming the reward from said retail center; and
Step 8) said retail center receiving reimbursement from said incentive company.

24. The method of training and rewarding a trainee of claim 23 wherein the rewards provided in step 6 is a you-did-it-right card that comprises an alpha-numeric identifier and spaces for biometric results of the health screening.

25. The method of training and rewarding a trainee of claim 24 wherein step 7 further comprises the sub-steps of:
Step 7A) employee logging onto a computer terminal and entering the alpha-numeric identifier from the you-did-it-right card;
Step 7B) computer terminal issuing employee a reward card redeemable at said retail center; and
Step 7C) employing redeeming said reward card at said retail center.

26. The method of training and rewarding a trainee of claim 25 wherein said reward is discount coupon having a unique identification number, information about in which retail centers said discount coupon may be redeemed, and details about the respective amounts of the redemptive value.

27. The method of training and rewarding a trainee of claim 25 wherein said reward is a gift card having a unique identification number, information about in which retail centers said gift card may be spent, and details about the respective amounts of the encoded value.

28. The method of training and rewarding a trainee of claim 25 wherein an additional step, step 5A, is inserted between step 5 and step 6 wherein said incentive company applies the additional sub-steps of:
first, using the results provided in step 5 and stratifying the employees into classifications ranging from high risk to medium risk to low risk and
second, allocating a reward value based on the classification and any improvement in said classification such as moving from a high risk to a medium risk.

29. The method of training and rewarding a trainee of claim 28 further comprising the additional steps of:
Step 8) said incentive company compiling statistics through the aggregation of medical examinations and health screenings data and data from reward redemptions;
Step 9) said incentive company analyzing statistics compiled in step 8; and
Step 10) said incentive company reporting aggregate statistics and respective analysis to said client company.

30. The method of training and rewarding a trainee of claim 28 wherein step 4 further comprises the medical firm providing a kiosk that tests and collects biometrics including height, weight, blood pressure, heart rate, age, and sex.

31. A method of training and rewarding a trainee comprising the steps of:
Step 1) providing an incentive company, a client company, a plurality of employees of said client company, and a retail center;
Step 2) said incentive company providing a training module and a rewards package, including you-did-it-right cards to said client company;
Step 3) said client company providing instruction opportunities to said employees;
Step 4) said client company providing employees with you-did-it-right cards, said you-did-it-right cards comprising an alpha-numeric identifier and spaces for recordation of information to be filled in by employee;
Step 5) said client company providing testing opportunities to said employees wherein the information contained in said instruction opportunities provided in step 3 is tested via peer employee observation;
Step 6) said employees recording observations made in step 5 on said you-did-it-right cards provided in step 4;
Step 7) said client company providing a reward to said employees for having recorded peer observation in step 6;
Step 8) said employee redeeming the reward from said retail center;
Step 9) said retail center receiving reimbursement from said incentive company;
Step 10) said incentive company compiling statistics through the aggregation of data recorded on you-did-it-right cards and reward redemptions;
Step 11) said incentive company analyzing statistics compiled in step 10 and documenting the details of the specific instances observed and recorded on the you-did-it-right cards; and
Step 12) said incentive company reporting statistics, respective analysis, and specific instances observed and recorded to said client company.

32. The method of training and rewarding a trainee of claim 31 wherein the alpha-numeric number printed on the you-did-it-right card links to a discount coupon having a unique identification number, information about in which retail centers said discount coupon may be redeemed, and details about the respective amounts of the redemptive value.
